(19) United States
(12) Patent Application Publication
(10) Pub. No.: US 2002/0029201 A1
(43) Pub. Date: Mar. 7, 2002

(54) Business privacy in the electronic marketplace

(76) Inventors: Zeev Barzilai, Tel Aviv (IL); Sergei Shmulyian, Givataim (IL); Onn Shehory, Neve Monosson (IL)

Correspondence Address: DARBY & DARBY P.C., 805 Third Avenue, New York, NY, 10022, US

(21) Appl. No.: 09/731,388

(22) Filed: Nov. 30, 2000

Related U.S. Application Data
(60) Provisional application No. 60/230,151, filed on Sep. 5, 2000.

(51) Int. Cl. G06F 17/60; G06F 7/00; G06F 17/30; H04K 1/00; H04L 9/00

(52) U.S. Cl. 705/80; 705/26; 705/50; 705/7; 707/9

(57) ABSTRACT

A method for controlling an exchange of information between a first party and a second party includes receiving from the first party a set of one or more privacy preferences, indicating restrictions to be placed on use of specified items of the information to be disclosed by the first party, and receiving from the second party a description of a privacy policy, indicating undertakings by the second party with regard to restricting the use of the specified items of the information. The compatibility of the privacy preferences with the privacy policy is assessed. If the privacy preferences and the privacy policy are found to be incompatible, a negotiation is brokered with at least one of the first and the second parties so as to bring the privacy preferences and the privacy policy into mutual compatibility. The information is provided from the first party to the second party only when the privacy preferences and the privacy policy are found to be compatible.

### CROSS-REFERENCE TO RELATED APPLICATIONS

This application claims the benefit of a U.S. provisional patent application entitled “Method and System for Enhancing Business Privacy in the Electronic Marketplace,” filed Sep. 5, 2000, which is incorporated herein by reference.

### FIELD OF THE INVENTION

The present invention relates generally to electronic commerce, and specifically to maintaining privacy of information in electronic transactions.

### BACKGROUND OF THE INVENTION

Traditionally, the protection and disclosure of business information belongs to the domain of confidentiality. Corporations commonly define certain internal information as being confidential and develop policies to prevent disclosure of the information to unauthorized parties. When there is a need to disclose confidential information to an outside party, it is typically subject to a confidential disclosure agreement (CDA), negotiated in a paperwork business process on a case-by-case basis.

Although most business-to-business interactions are not subject to such strict restrictions on information exchange, there is still a great deal of intelligence that can be gleaned from these exchanges. A simple product inquiry or purchase order, for example, can reveal sensitive information that many businesses would like to keep private. While disclosure of such private information between the partners to the transaction is generally unavoidable, businesses (as well as individuals) may seek to restrict the subsequent use or distribution of this information by the transaction partner.

Maintaining privacy of business information is a particularly acute problem in the context of the electronic marketplace. Increasing numbers of businesses, as well as consumers, buy and sell goods and services over the Internet. Web sites that serve as “marketplaces,” which enable buyers to search and compare prices and terms among multiple vendors, are rapidly growing in popularity. Any user of such a Web site exposes a range of his or her private information including name, address, Web surfing habits, financial information, purchasing needs and deals that may be in progress. Both the marketplace and vendors can use this information for business intelligence analysis. The results of the analysis can be used for targeted telemarketing and can also be sold to third parties. Consumers may be bothered by subsequent junk mail sent to them as a result of such analysis and resale of information. For businesses, however, unrestricted distribution of this private information can have more serious consequences, particularly if it falls into the hands of competitors or of other businesses with whom they are in negotiations.

In response to the need to protect private information, electronic marketplaces and other Web sites have begun to establish and post their own privacy policies. Visitors to such sites are invited to check the privacy policies upon entering the site, in order to know in advance how the private information that they disclose will be treated. To facilitate this process, the World Wide Web Consortium has undertaken the Platform for Privacy Preferences Project (P3P), which is described at www.w3.org/P3P. P3P is envisioned as an industry standard for providing a simple, automated way for users to gain more control over the use of personal information on Web sites they visit. It provides a standardized set of multiple-choice questions, covering major aspects of a Web site's privacy policies, in order to give a “snapshot” of how a site handles personal information about its users. P3P-enabled Web sites make this information available in a standard, machine-readable format. P3P-enabled browsers can read this snapshot automatically and compare it to the consumer's own set of privacy preferences. If there is a mismatch between the site's privacy policy and the user's preferences, the user then has the option of not conducting further business with the site.

### SUMMARY OF THE INVENTION

From the point of view of businesses seeking to buy and sell items of goods and services in the electronic marketplace, the tools that are currently available for protecting private information are inadequate. The privacy policies posted by electronic marketplaces and other Web sites are inflexible, requiring customers to make an “all-or-nothing” decision as to whether to accept or reject the posted policy before even making an inquiry. (At best, a customer may select a check box on screen to ask to be left off future mailing lists.) Examples of the inflexibility of current privacy approaches include the following:

There is no provision in such privacy policies to allow the customer to make a staged disclosure as a transaction progress, starting with an anonymous inquiry, for example, followed by submission of purchase information when the customer actually decides to make a purchase.

There is no possibility of negotiating terms of privacy protection, except by the conventional CDA route, or of providing different preferences among which the customer may choose.

While an electronic marketplace may post and abide by its own privacy policy, vendors offering items through the marketplace may have their own privacy policies that are incompatible with that of the marketplace, or they may have no such policies at all.

Preferred embodiments of the present invention provide a flexible framework in which parties doing business in an electronic commerce setting can automatically negotiate the terms of privacy protection to be provided, by matching privacy criteria that the parties have defined in advance. This framework is useful particularly in business-to-business (B2B) interactions, and especially in interactions carried out through an intermediary electronic marketplace or portal. More generally , however, the principles of the present invention are applicable to substantially any type of electronic commerce setting, including business-to-consumer (B2C) and mixed B2C/B2B settings.

In some preferred embodiments of the present invention, an electronic marketplace serves as a broker of private information between a buyer and one or more sellers. Upon logging into the marketplace, the buyer is preferably prompted to select a default privacy policy, typically from among a number of alternative policies offered by the marketplace. Alternatively, the buyer may input his or her own privacy preferences, preferably based on a standard form or language for recording privacy preferences and choices, such as an extension of the above-mentioned P3P standard.

The preferences specified by the buyer indicate which private information may be disclosed to the marketplace, and which may be disclosed to the sellers, and at what stages of the planned transaction. The preferences also specify the uses to which the marketplace and sellers may put the private information. Some of the private information may be encrypted, so that the marketplace can pass it through to a selected seller but cannot access the information itself. Preferably, the privacy preferences defined by the buyer and/or by the marketplace include alternative positions and/or flexible, logical guidelines, so that a mutually-acceptable policy can be negotiated automatically if there is a mismatch between the preferences that are specified initially.

After the buyer and marketplace have agreed on the privacy policy, the buyer submits a query or purchase order to the marketplace for a desired item of goods or services. The marketplace then finds one or more sellers offering the desired item and attempts to match the privacy policy agreed upon with the buyer to the sellers' proposed privacy policies. At this stage, too, the policies proposed by the sellers preferably include alternative or fallback positions, so that the marketplace can automatically negotiate a final policy acceptable to all of the parties. Only then is the buyer's information passed to the seller, who decrypts the information if necessary and fills the order. Optionally, if indicated by the agreed-upon policy, the buyer's private information is passed to the seller in stages, as the transaction progresses. Upon completion of the transaction, the marketplace and seller are entitled to record, analyze, use and distribute the buyer's private information and buying behavior only to the extent allowed by the agreed-upon policy.

There is therefore provided, in accordance with a preferred embodiment of the present invention, a method for controlling an exchange of information between a first party and a second party, including:

receiving from the first party a set of one or more privacy preferences, indicating restrictions to be placed on use of specified items of the information to be disclosed by the first party;

receiving from the second party a description of a privacy policy, indicating undertakings by the second party with regard to restricting the use of the specified items of the information;

assessing compatibility of the privacy preferences with the privacy policy;

if the privacy preferences and the privacy policy are found to be incompatible, brokering a negotiation with at least one of the first and the second parties so as to bring the privacy preferences and the privacy policy into mutual compatibility; and

providing the information from the first party to the second party only when the privacy preferences and the privacy policy are found to be compatible.

Preferably, the restrictions indicated by the set of privacy preferences include restrictions on disclosure of the specified items of the information to third parties. Alternatively or additionally, the restrictions indicated by the set of privacy preferences include restrictions on analysis of the information and/or a description of a condition subject to which the first party will permit one of the specified items to be used by the second party.

Preferably, the first and second parties exchange the information via a computer network, and receiving the privacy preferences and the privacy policy includes receiving the preferences and the policy via the network. Additionally or alternatively, the second party is one of a plurality of parties eligible to receive the information, and assessing the compatibility of the privacy preferences includes selecting the second party from among the plurality of eligible parties responsive to the compatibility of the privacy preferences with the privacy policy of the second party.

Preferably, providing the information includes conducting a transaction between the first and second parties based on the information, wherein the transaction is conducted in a sequence of stages, and wherein providing the information includes providing different ones of the specified items at each of two or more different stages of the transaction, in a manner specified by the set of privacy preferences. Additionally or alternatively, conducting the transaction includes submitting a purchase order containing the information from the first party to the second party, whereupon the second party fills the purchase order.

Further preferably, providing the information includes passing the information through an intermediary, which receives the privacy preferences and the privacy policy and brokers the negotiation if the privacy preferences and the privacy policy are found to be incompatible. Preferably, the intermediary includes an electronic marketplace, which is accessed by the first and second parties via a computer network. Additionally or alternatively, assessing the compatibility of the privacy preferences with the privacy policy includes establishing an intermediary privacy policy, responsive to the privacy preferences, subject to which the first party is to communicate with the intermediary, and assessing the compatibility of the intermediary privacy policy with the privacy policy of the second party. Most preferably, providing the information includes conveying the information via the intermediary, wherein a portion of the information is provided in an encrypted form, in accordance with the privacy preferences, for decryption only by the second party and not by the intermediary.

There is also provided, in accordance with a preferred embodiment of the present invention, a method for electronic commerce, including:

establishing a privacy policy restricting use of information to be revealed by a buyer to an electronic marketplace in connection with a transaction to be carried out by the buyer through the marketplace;

subject to the privacy policy, receiving the information from the buyer, including a description of an item desired to be procured for the buyer;

locating a seller in communication with the marketplace offering the item;

receiving from the seller an undertaking to restrict the use of the information in accordance with the privacy policy; and

providing the information to the seller, subject to the undertaking, responsive to which information the seller conveys the item to the buyer.

In a preferred embodiment, receiving the information includes tracking and analyzing behavior of the buyer while the buyer is visiting the marketplace in order to derive purchase behavior data regarding the buyer, and including limiting use of the data in accordance with a restriction imposed by the privacy policy.

There is additionally provided, in accordance with a preferred embodiment of the present invention, apparatus for controlling an exchange of information between a first party and a second party, including an information exchange server, arranged to receive from the first party a set of one or more privacy preferences, indicating restrictions to be placed on use of specified items of the information to be disclosed by the first party, and to receive from the second party a description of a privacy policy, indicating undertakings by the second party with regard to restricting the use of the specified items of the information, and to assess compatibility of the privacy preferences with the privacy policy, such that if the privacy preferences and the privacy policy are found to be incompatible, the server brokers a negotiation with at least one of the first and the second parties so as to bring the privacy preferences and the privacy policy into mutual compatibility, and to convey the information from the first party to the second party only when the privacy preferences and the privacy policy are found to be compatible.

There is further provided, in accordance with a preferred embodiment of the present invention, apparatus for maintaining an electronic marketplace, including an electronic commerce server arranged to establish a privacy policy restricting use of information to be revealed by a buyer to the server in connection with a transaction to be carried out by the buyer through the server and, subject to the privacy policy, to receive the information from the buyer, including a description of an item desired to be procured for the buyer, to locate a seller in communication with the marketplace offering the item, to receive from the seller an undertaking to restrict the use of the information in accordance with the privacy policy, and to provide the information to the seller, subject to the undertaking, responsive to which information the seller conveys the item to the buyer.

There is moreover provided, in accordance with a preferred embodiment of the present invention, a system for controlling an exchange of information, including:

a first computer, provided with a set of one or more privacy preferences, indicating restrictions to be placed on use of specified items of the information to be disclosed by the first party;

a second computer, provided with a description of a privacy policy, indicating undertakings by the second party with regard to restricting the use of the specified items of the information; and

an information exchange server, coupled to communicate with the first and second computers via a computer network, and arranged to assess compatibility of the privacy preferences with the privacy policy, such that if the privacy preferences and the privacy policy are found to be incompatible, the server brokers a negotiation with at least one of the first and the second parties so as to bring the privacy preferences and the privacy policy into mutual compatibility, and further arranged to provide the information from the first party to the second party only when the privacy preferences and the privacy policy are found to be compatible.

There is furthermore provided, in accordance with a preferred embodiment of the present invention, a system for electronic commerce, including:

a buyer computer, operated by a buyer;

one or more seller computers, operated by respective sellers; and

an electronic commerce server coupled to communicate with the buyer and seller computers via a computer network, and arranged to establish a privacy policy restricting use of information to be revealed by the buyer computer to the server in connection with a transaction to be carried out by the buyer computer through the server and, subject to the privacy policy, to receive the information from the buyer computer, including a description of an item desired to be procured for the buyer, to identify one of the seller computers making an offer to supply the item, to receive from the seller computer an undertaking to restrict the use of the information in accordance with the privacy policy, and to provide the information to the seller computer, subject to the undertaking, responsive to which information the respective seller conveys the item to the buyer.

There is additionally provided, in accordance with a preferred embodiment of the present invention, a computer software product for controlling an exchange of information between a first party and a second party, the product including a computer-readable medium in which program instructions are stored, which instructions, when read by a computer, cause the computer to receive from the first party a set of one or more privacy preferences, indicating restrictions to be placed on use of specified items of the information to be disclosed by the first party, and to receive from the second party a description of a privacy policy, indicating undertakings by the second party with regard to restricting the use of the specified items of the information, and to assess compatibility of the privacy preferences with the privacy policy, and if the privacy preferences and the privacy policy are found to be incompatible, to broker a negotiation with at least one of the first and the second parties so as to bring the privacy preferences and the privacy policy into mutual compatibility, and to provide the information from the first party to the second party only when the privacy preferences and the privacy policy are found to be compatible.

There is still further provided, in accordance with a preferred embodiment of the present invention, a computer software product for electronic commerce, the product including a computer-readable medium in which program instructions are stored, which instructions, when read by a computer, cause the computer to establish a privacy policy restricting use of information to be revealed by a buyer to an electronic marketplace in connection with a transaction to be carried out by the buyer through the marketplace, and subject to the privacy policy, to receive the information from the buyer, including a description of an item desired to be procured from the buyer, and to locate a seller in communication with the marketplace offering the item, and to receive from the seller an undertaking to restrict the use of the information in accordance with the privacy policy, and to provide the information to the seller, subject to the undertaking, responsive to which information the seller conveys the item to the buyer.

The present invention will be more fully understood from the following detailed description of the preferred embodiments thereof, taken together with the drawings in which:

### BRIEF DESCRIPTION OF THE DRAWINGS

FIG. 1 is a schematic, pictorial illustration of a system for electronic commerce, in accordance with a preferred embodiment of the present invention;

FIG. 2 is a flow chart that schematically illustrates a method for carrying out an electronic transaction subject to a privacy policy negotiated among the parties to the transaction, in accordance with a preferred embodiment of the present invention;

FIG. 3 is a flow chart that schematically illustrates a method for negotiating a privacy policy between a buyer and an electronic marketplace, in accordance with a preferred embodiment of the present invention;

FIG. 4 is a flow chart that schematically illustrates a method for handling private information provided by a buyer to an electronic marketplace, in accordance with a preferred embodiment of the present invention; and

FIG. 5 is a flow chart that schematically illustrates a method for concluding an electronic transaction and for using private information conveyed in the course of the transaction, in accordance with a preferred embodiment of the present invention.

### DETAILED DESCRIPTION OF PREFERRED EMBODIMENTS

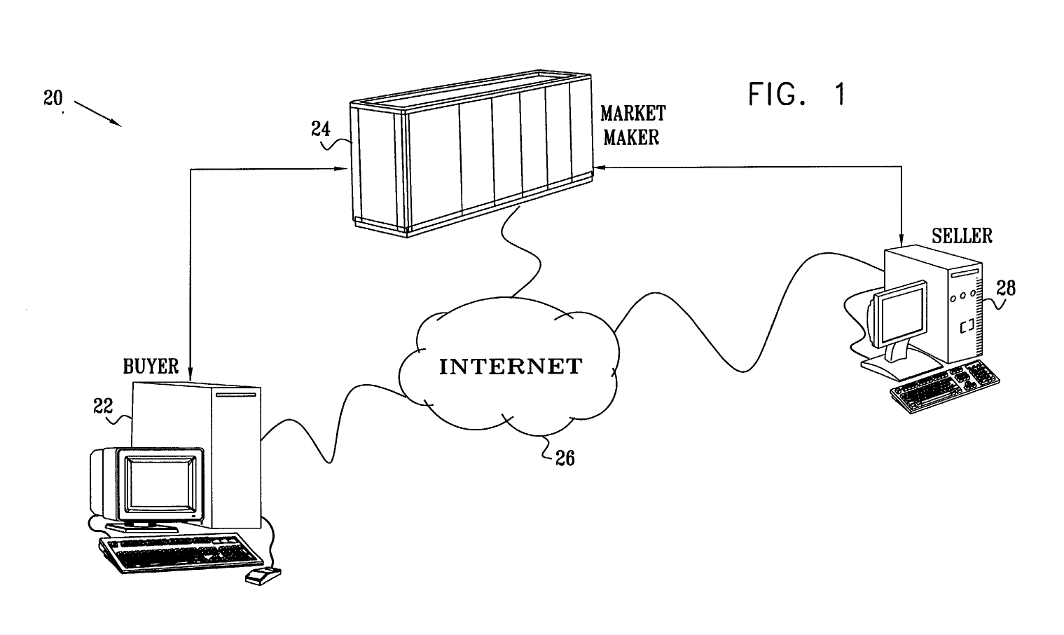

FIG. 1 is a schematic, pictorial illustration showing a system 20 for electronic commerce, in accordance with a preferred embodiment of the present invention. A buyer 22, typically a business seeking to purchase goods or services that it needs, establishes a connection with an electronic marketplace, referred to hereinbelow as a market maker 24, via a network 26, such as the Internet. Typically, the market maker operates a Web site or portal, giving the buyer access to a range of sellers, such as a seller 28, who offer the type of items that the buyer needs. Such market makers commonly present a catalog or other listing of available items, consolidating the offerings of many sellers and giving the buyer a range of item types, prices and supply terms from which to choose. When the buyer orders an item from the catalog or specifies his buying preferences in some other acceptable manner, the market maker selects the appropriate seller and passes the buyer's order on to the seller for fulfillment.

The functions of buyer 22, market maker 24 and seller 28 are carried by computers linked to network 26, as shown in the figure. These computers are equipped with software for performing transactions automatically, with minimal user involvement other than updating the listing of available items at the seller's side and indicating the items desired at the buyer's. Software for these purposes is known in the art. In preferred embodiments of the present invention, as described hereinbelow, the computer software also provides for definition of machine-readable privacy preferences and automated negotiation of a flexible privacy policy among the buyer, market maker and seller. Software for this purpose may be supplied to the computers in electronic form, over network 26, for example, or it may alternatively be supplied on tangible media, such as CD-ROM.

In describing methods for electronic commerce and privacy protection hereinbelow, for the sake of clarity, reference is made specifically to system 20 as a model for implementation of the present invention. It will be understood, however, that the present invention is not limited in any way to this specific application environment. Rather, the principles of the present invention may be applied in substantially any electronic commerce setting in which protection of privacy of information is desired. More generally, these principles can be brought to bear in other contexts for the control the exchange of sensitive information among computers communicating over electronic media, as a more efficient alternative to case-by-case confidential disclosure agreements.

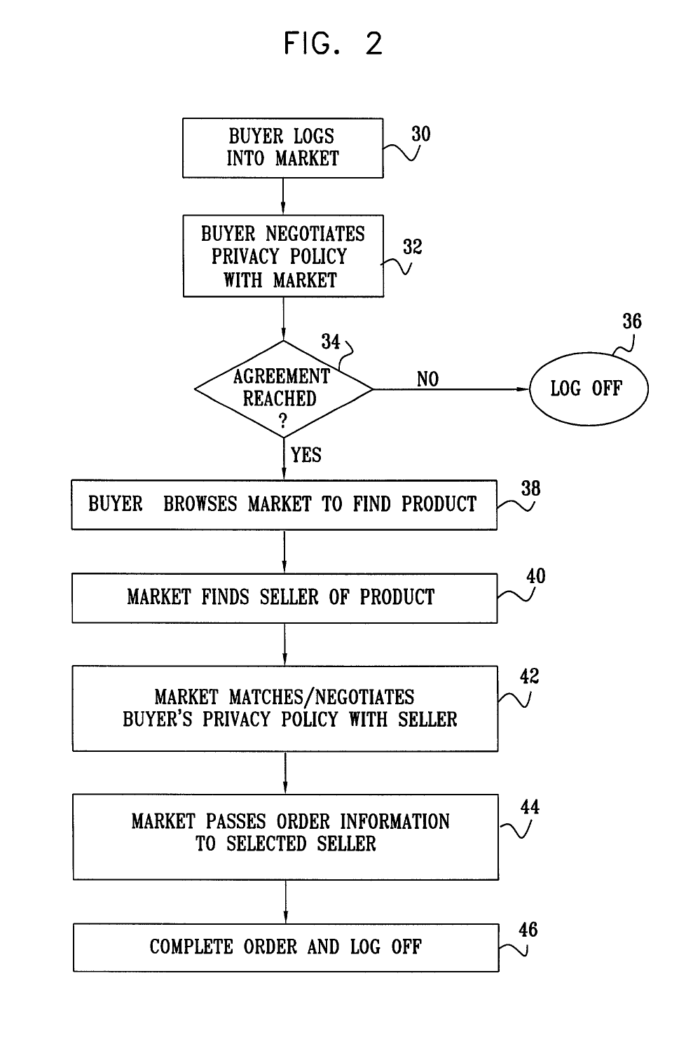

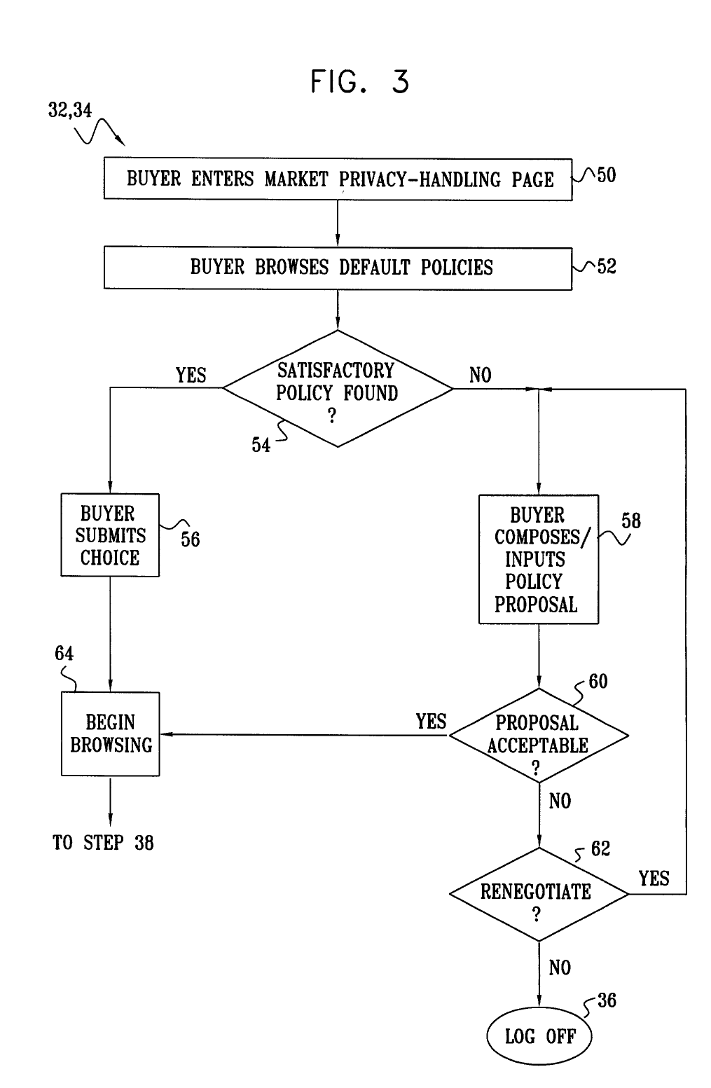

FIG. 2 is a flow chart that schematically illustrates a method for carrying out an electronic transaction between buyer 22 and seller 28 through market maker 24, in accordance with a preferred embodiment of the present invention. The buyer, seeking to purchase an item of goods or services of a particular type, logs into the market maker's Web site, at a log-in step 30. Before proceeding to browse the site for the desired item, the buyer is invited to negotiate and conclude an agreed-upon privacy policy with the market maker, at a buyer privacy negotiation step 32. A preferred implementation of this step is described in detail hereinbelow with reference to FIG. 3. If the buyer and market maker reach agreement on a privacy policy, at an agreement step 34, the buyer proceeds with the transaction. Otherwise, if the buyer has strong privacy preferences that cannot be satisfied by the criteria of the market maker's privacy policy, the buyer leaves the market maker's Web site, at a log-off step 36. Preferably, if the buyer has made purchases from this market maker in the past, so that a privacy policy was already mutually agreed on at a previous transaction and has not since been changed, steps 32 and 34 can be skipped.

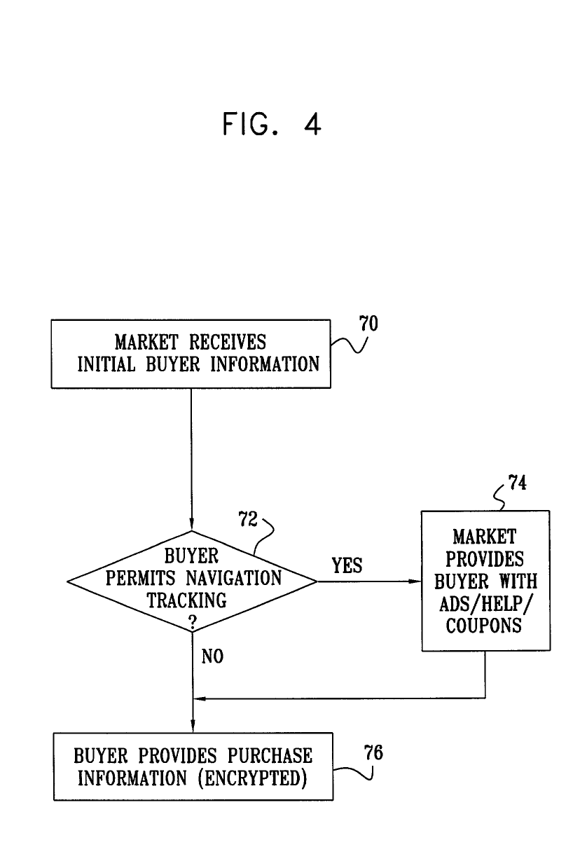

Once the privacy policy is concluded, the buyer browses the market maker's listings of goods and services, referred to herein as the market maker's catalog, to find the desired item, at a browsing step 38. At this stage, the market maker receives information from the buyer that may be subject to the privacy policy negotiated at step 32. Handling of this private information by the market maker is described hereinbelow with reference to FIG. 4. The market maker uses the information received from the buyer to find one or more sellers of the item that the buyer has requested, at a seller search step 40. Of course, the market maker must be able to use at least the portion of the buyer's private information that is necessary to identify the appropriate seller or sellers. It may also be necessary to pass sufficient information to the seller so that an updated price quote and delivery schedule can be obtained. Depending on the agreed-upon privacy policy, however, other portions of the buyer's private information may be hidden from the market maker, preferably by encryption, and may be withheld from the seller until the buyer has accepted the offer.

When the seller of the desired item has been identified, the market maker must confirm that the seller undertakes to abide by the buyer's agreed privacy policy, at a seller privacy negotiation step 42. If the buyer has a privacy preferences that match the proposed policy listed by the seller, the market maker can proceed with the transaction. Otherwise, another automated negotiation must take place, typically matching the policy proposed by the seller against the alternative preferences listed by the buyer and by the market maker. If no agreement is reached, the market maker will not pass the buyer's private information on to the seller, and there will be no transaction concluded with this seller. The market maker may instead attempt to match or negotiate the buyer's agreed privacy policy with another seller offering the desired item. The possibility of losing business due to such failed privacy negotiations provides sellers with an incentive to define proposed policies that are as flexible as possible.

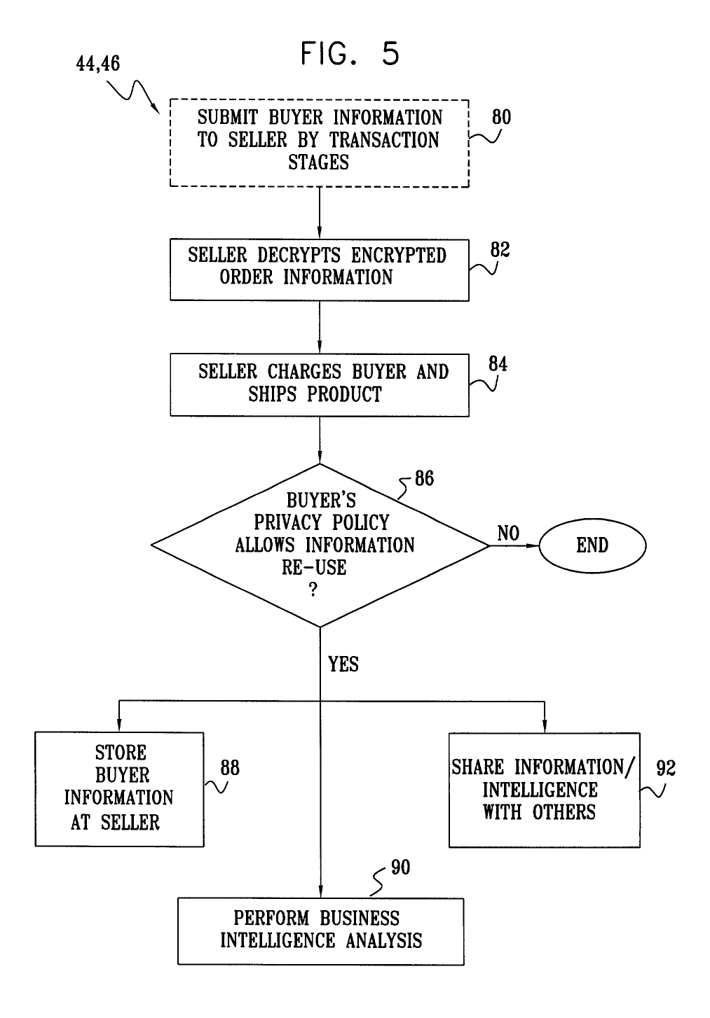

Once the privacy policy has been agreed upon with the seller, the market passes the buyer's order information on to the seller, at an order step 44. The seller processes the order, at a completion step 46, including charging the buyer for the item and shipping it to the buyer's address as appropriate. Details of a preferred implementation of these steps are described hereinbelow with reference to FIG. 5. If allowed by the agreed privacy policy, the seller and/or the market maker may process and use the information gleaned from the transaction for the purposes of business intelligence and follow-up. Upon completion of the transaction, the buyer logs off.

FIG. 3 is a flow chart that schematically illustrates a method for selecting or negotiating a privacy policy between buyer 22 and market maker 24, in accordance with a preferred embodiment of the present invention. Upon entering the market maker's Web site, the buyer is directed to a privacy handling page in the site, at a page direction step 50. Preferably, the market maker offers a number of alternative default policies among which the buyer can choose, at a policy browsing step 52. The policies define what elements of the buyer's private information will be submitted to the market maker, and what elements can be submitted by the market maker to possible sellers. The policies may also indicate at what stage certain elements of the information will be submitted to the market maker and/or to the seller, enabling a phased disclosure as the transaction proceeds, as noted above. In addition, the policies may specify the uses to which the market maker and/or seller may put the information they receive.

An exemplary policy for use in the setting business-to-business (B2B) purchasing could be the following:

No buyer financial information to be passed to any parties other than the seller.

No buyer contact information to be passed to any parties other than the seller.

Buyer contact information to be passed to the seller only after privacy policy has been agreed upon (at step 42, FIG. 2).

Business intelligence analysis may be performed by the market maker and used by the seller and seller's partners, but by no other parties. Various definitions of the seller's “partners” may be used in this context. For example, a partner may be an entity that is identified as such by the seller and shares the seller's privacy policy or has a stricter policy. Alternatively or additionally, a partner may be an entity that meets certain criteria in the buyer's privacy preferences. (Of course, the buyer's privacy preferences may specify that no information is to be disclosed to any party other than the seller.)

The market maker and seller may not collect data on the buyer's procurement patterns.

Final order details to be passed to the seller in encrypted form (typically using the seller's public key, as is known in the art) and hidden from the market maker and all others.

This policy is listed by way of example, and alternative policies will be apparent to those skilled in the art. For example, the buyer might select a policy that allows certain contact or procurement information to be passed to other sellers, as well, in order to receive information regarding new products and price changes occurring in the market of interest. The market maker may also offer incentives to induce buyers to choose more permissive privacy policies.

If the buyer finds an acceptable default policy, at a policy selection step 54, the buyer submits the choice to the market maker, at a policy submission step 56. The buyer can then browse the market maker's catalog or input details of the desired item for purchase, at a browsing initiation step 64.

Alternatively, if none of the default policies offered by the market maker meet the buyer's requirements, the buyer specifies his or her preferences, at a proposal step 58. Preferably, the buyer's preferences are expressed in a standard format or language, such as an extension of the P3P standard mentioned above. Most preferably, the format provides a listing of types or fields of information and possible recipients of the information, and allows the buyer to specify one of the following choices for each [field, recipient] pair:

Always disclose.

Never disclose.

Optionally disclose subject to one or more specified conditions.

Preferably, the format provides for various types of conditions to be specified, and also allows the buyer to indicate that he or she is willing to forego a given optional preference as needed, if the market maker or a particular seller is unwilling to accept it. Examples of conditions that the buyer can specify include the following:

A certain phase of the transaction has been reached.

The seller fits certain criteria specified by the buyer, such as size, visibility, affiliation with industry groups, customer privacy protection record, etc. (It is assumed that data regarding these criteria are available to the marketplace.)

The seller appears on a list of names of companies with whom the buyer is or is not prepared to do business.

The market maker evaluates the buyer's selected preferences, at a proposal evaluation step 60. If the preferences are compatible with general privacy policy guidelines maintained by the market maker, the market maker returns its acceptance of the proposal to the buyer, and the transaction continues from step 64. On the other hand, if there are points in the buyer's preferences that are not acceptable to the market maker or are expected to be unacceptable to potential sellers, the market maker preferably prompts the buyer to renegotiate the privacy terms, at a renegotiation step 62. At this point, the buyer has the choice of modifying one or more of his or her preferences, or of logging off the site.

FIG. 4 is a flow chart that schematically illustrates a method for handling information provided by buyer 22 in the course of browsing and making a transaction through market maker 24, in accordance with a preferred embodiment of the present invention. Once the buyer and market maker have agreed on the privacy policy to cover their interaction, the buyer inputs initial purchase information to the market maker, at an initial submission step 70. This information is necessary in order for the buyer to browse the market maker's on-line catalog, as well as for the market maker to locate the sellers offering goods or services that meet the buyer's requirements. If the agreed privacy policy allows, the market maker tracks the buyer's purchase needs and navigation in the market maker's Web site, at a tracking step 72. The market maker can then present the buyer with targeted advertising, help, discount coupons, etc., at a buyer assistance step 74, as is known in the art. On the other hand, the privacy policy choices offered by the marker maker enable the buyer who does not wish to receive these sorts of assistance to opt out of them in advance.

At a purchase information step 76, the buyer inputs to the market maker financial and delivery information necessary for completing the transaction with the buyer. In accordance with the privacy policy, the buyer may choose to provide this information only when a seller has been located offering the desired item with an acceptable price and terms. In any case, the market maker provides the information only to the seller with whom the transaction is to be made, unless the agreed privacy policy allows the market maker to give all or part of the information to other parties. Alternatively or additionally, as noted above, the buyer may provide the purchase information in an encrypted form that can be decrypted only by the selected seller. Further alternatively or additionally, if the buyer has sufficient trust in the market maker, the purchase information can be provided by the buyer with the initial information submission, at step 70, in order to save time in concluding the transaction when the suitable seller is found.

FIG. 5 is a flow chart that schematically illustrates a method for concluding the transaction between buyer 22 and seller 28, as well as for using the information provided by the buyer in the course of transaction, in accordance with a preferred embodiment of the present invention. Optionally, as noted above, the buyer's private information is conveyed to the seller in stages, at a staged submission step 80. For example, the buyer may remain anonymous to the seller during the browsing stage, followed by disclosure of the buyer's name and address upon requesting a quote, with full disclosure of buyer details provided only after a purchase agreement is reached.

Once the buyer has accepted the seller's offer, the seller receives the buyer's order information and decrypts any of the data that are encrypted, at a decryption step 82. Based on the order information, the seller charges the buyer's credit card or other account and ships the goods to the buyer, at an order conclusion step 84. At an information re-use step 86, both the market maker and the seller are required to determine whether the privacy policy agreed upon with the buyer allows either of them to make further use of the information provided in the course of the transaction. If the policy forbids re-use of the buyer's information, in whole or in part, the market maker and seller must purge their records of the forbidden information. Typical business practice, however, provides that at least some of the buyer information is to be stored, by the seller and/or the market maker, at a storage step 88.

In addition, if permitted by the privacy policy, the seller and/or market maker perform business intelligence analysis of the transaction, at an analysis step 90. As is known in the art, this analysis can provide useful information on the buyer's needs and preferences, enabling the seller and market maker to improve their service to the seller in the future and to offer the seller targeted advertising and promotions. In addition, in accordance with the privacy policy, the market maker and/or the seller may share elements of the information provided by the buyer and of the results of the business intelligence analysis with other parties, at a sharing step 92. The privacy policy preferably specifies which portions of the information can be shared and with whom.

It will be appreciated that the preferred embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for controlling an exchange of information between a first party and a second party, comprising:
receiving from the first party a set of one or more privacy preferences, indicating restrictions to be placed on use of specified items of the information to be disclosed by the first party;
receiving from the second party a description of a privacy policy, indicating undertakings by the second party with regard to restricting the use of the specified items of the information;
assessing compatibility of the privacy preferences with the privacy policy;
if the privacy preferences and the privacy policy are found to be incompatible, brokering a negotiation with at least one of the first and the second parties so as to bring the privacy preferences and the privacy policy into mutual compatibility; and
providing the information from the first party to the second party only when the privacy preferences and the privacy policy are found to be compatible.

2. A method according to claim 1, wherein the restrictions indicated by the set of privacy preferences comprise restrictions on disclosure of the specified items of the in formation to third parties.

3. A method according to claim 1, wherein the restrictions indicated by the set of privacy preferences comprise restrictions on analysis of the information.

4. A method according to claim 1, wherein the set of privacy preferences comprises a description of a condition subject to which the first party will permit one of the specified items to be used by the second party.

5. A method according to claim 1, wherein the first and second parties exchange the information via a computer network, and wherein receiving the privacy preferences and the privacy policy comprises receiving the preferences and the policy via the network.

6. A method according to claim 1, wherein the second party is one of a plurality of parties eligible to receive the information, and wherein assessing the compatibility of the privacy preferences comprises selecting the second party from among the plurality of eligible parties responsive to the compatibility of the privacy preferences with the privacy policy of the second party.

7. A method according to claim 1, wherein providing the information comprises conducting a transaction between the first and second parties based on the information.

8. A method according to claim 7, wherein the transaction is conducted in a sequence of stages, and wherein providing the information comprises providing different ones of the specified items at each of two or more different stages of the transaction, in a manner specified by the set of privacy preferences.

9. A method according to claim 7, wherein conducting the transaction comprises submitting a purchase order containing the information from the first party to the second party, whereupon the second party fills the purchase order.

10. A method according to claim 1, wherein providing the information comprises passing the information through an intermediary, which receives the privacy preferences and the privacy policy and brokers the negotiation if the privacy preferences and the privacy policy are found to be incompatible.

11. A method according to claim 10, wherein the intermediary comprises an electronic marketplace, which is accessed by the first and second parties via a computer network.

12. A method according to claim 10, wherein assessing the compatibility of the privacy preferences with the privacy policy comprises establishing an intermediary privacy policy, responsive to the privacy preferences, subject to which the first party is to communicate with the intermediary, and assessing the compatibility of the intermediary privacy policy with the privacy policy of the second party.

13. A method according to claim 12, wherein providing the information comprises conveying the information via the intermediary, wherein a portion of the information is provided in an encrypted form, in accordance with the privacy preferences, for decryption only by the second party and not by the intermediary.

14. A method for electronic commerce, comprising:
establishing a privacy policy restricting use of information to be revealed by a buyer to an electronic marketplace in connection with a transaction to be carried out by the buyer through the marketplace;
subject to the privacy policy, receiving the information from the buyer, including a description of an item desired to be procured for the buyer;
locating a seller in communication with the marketplace offering the item;
receiving from the seller an undertaking to restrict the use of the information in accordance with the privacy policy; and
providing the information to the seller, subject to the undertaking, responsive to which information the seller conveys the item to the buyer.

15. A method according to claim 14, wherein establishing the privacy policy comprises receiving from the buyer a set of one or more privacy preferences with regard to specified items of the information to be provided by the buyer, and determining the privacy policy so as to accord with the received preferences.

16. A method according to claim 15, wherein determining the privacy policy comprises assessing compatibility of the privacy preferences with policy guidelines of the marketplace and, if the privacy preferences and the policy guidelines are found to be incompatible, negotiating with the buyer so as to bring the privacy preferences into compatibility with the guidelines.

17. A method according to claim 15, wherein receiving the undertaking from the seller comprises receiving privacy proposals from multiple sellers in communication with the marketplace, and selecting at least one of the sellers whose privacy proposal accords with the buyer's privacy preferences.

18. A method according to claim 14, wherein the transaction is carried out in a sequence of stages, and wherein providing the information to the seller comprises disclosing different portions of the information at different stages of the transaction, in accordance with the privacy policy.

19. A method according to claim 14, wherein receiving the information comprises receiving a portion of the information in an encrypted form inaccessible to the marketplace, in accordance with the privacy policy, and wherein providing the information to the seller comprises providing the encrypted portion of the information to the seller, who is enabled to decrypt the information.

20. A method according to claim 14, wherein receiving the information comprises tracking and analyzing behavior of the buyer while the buyer is visiting the marketplace in order to derive purchase behavior data regarding the buyer, and comprising limiting use of the data in accordance with a restriction imposed by the privacy policy.

21. Apparatus for controlling an exchange of information between a first party and a second party, comprising an information exchange server, arranged to receive from the first party a set of one or more privacy preferences, indicating restrictions to be placed on use of specified items of the information to be disclosed by the first party, and to receive from the second party a description of a privacy policy, indicating undertakings by the second party with regard to restricting the use of the specified items of the information, and to assess compatibility of the privacy preferences with the privacy policy, such that if the privacy preferences and the privacy policy are found to be incompatible, the server brokers a negotiation with at least one of the first and the second parties so as to bring the privacy preferences and the privacy policy into mutual compatibility, and to convey the information from the first party to the second party only when the privacy preferences and the privacy policy are found to be compatible.

22. Apparatus according to claim 21, wherein the restrictions indicated by the set of privacy preferences comprise restrictions on disclosure of the specified items of the information to third parties.

23. Apparatus according to claim 21, wherein the restrictions indicated by the set of privacy preferences comprise restrictions on analysis of the information.

24. Apparatus according to claim 21, wherein the set of privacy preferences comprises a description of a condition subject to which the first party will permit one of the specified items to be used by the second party.

25. Apparatus according to claim 21, wherein the server is coupled to exchange the information with the first and second parties via a computer network, and to receive the privacy preferences and the privacy policy via the network.

26. Apparatus according to claim 21, wherein the second party is one of a plurality of parties eligible to receive the information, and wherein the server is adapted to select the second party from among the plurality of eligible parties responsive to the compatibility of the privacy preferences with the privacy policy of the second party.

27. Apparatus according to claim 21, wherein the information is conveyed by the server in the context of a transaction between the first and second parties based on the information.

28. Apparatus according to claim 27, wherein the transaction is conducted in a sequence of stages, and wherein the server is arranged to convey different ones of the specified items at each of two or more different stages of the transaction, in a manner specified by the set of privacy preferences.

29. Apparatus according to claim 27, wherein the server is arranged to convey a purchase order containing the information from the first party to the second party, whereupon the second party fills the purchase order.

30. Apparatus according to claim 21, wherein the server comprises an electronic marketplace server, which is accessed by the first and second parties via a computer network.

31. Apparatus according to claim 21, wherein the server is arranged to establish an intermediary privacy policy, responsive to the privacy preferences, subject to which the first party is to communicate with the server, and to assess the compatibility of the intermediary privacy policy with the privacy policy of the second party.

32. Apparatus according to claim 31, wherein the server is arranged to receive a portion of the information from the first party in an encrypted form, in accordance with the privacy preferences, and to convey the encrypted information for decryption only by the second party.

33. Apparatus for maintaining an electronic marketplace, comprising an electronic commerce server arranged to establish a privacy policy restricting use of information to be revealed by a buyer to the server in connection with a transaction to be carried out by the buyer through the server and, subject to the privacy policy, to receive the information from the buyer, including a description of an item desired to be procured for the buyer, to locate a seller in communication with the marketplace offering the item, to receive from the seller an undertaking to restrict the use of the information in accordance with the privacy policy, and to provide the information to the seller, subject to the undertaking, responsive to which information the seller conveys the item to the buyer.

34. Apparatus according to claim 33, wherein the server is arranged to receive from the buyer a set of one or more privacy preferences with regard to specified items of the information to be provided by the buyer, and to determine the privacy policy so as to accord with the received preferences.

35. Apparatus according to claim 34, wherein the server is arranged to assess compatibility of the privacy preferences with policy guidelines of the marketplace and, if the privacy preferences and the policy guidelines are found to be incompatible, to negotiate with the buyer so as to bring the privacy preferences into compatibility with the guidelines.

36. Apparatus according to claim 34, wherein the server is arranged to receive privacy proposals from multiple sellers in communication with the marketplace, and to select at least one of the sellers whose privacy proposal accords with the buyer's privacy preferences.

37. Apparatus according to claim 33, wherein the transaction is carried out in a sequence of stages, and wherein the server is arranged to disclose different portions of the information at different stages of the transaction, in accordance with the privacy policy.

38. Apparatus according to claim 33, wherein the server is arranged to receive a portion of the information in an encrypted form inaccessible to the marketplace, in accordance with the privacy policy, and to provide the encrypted portion of the information to the seller, who is enabled to decrypt the information.

39. Apparatus according to claim 33, wherein the server is arranged to track and analyze behavior of the buyer while the buyer is visiting the marketplace in order to derive purchase behavior data regarding the buyer, and to limit use of the data in accordance with a restriction imposed by the privacy policy.

40. A system for controlling an exchange of information, comprising:
a first computer, provided with a set of one or more privacy preferences, indicating restrictions to be placed on use of specified items of the information to be disclosed by the first party;
a second computer, provided with a description of a privacy policy, indicating undertakings by the second party with regard to restricting the use of the specified items of the information; and
an information exchange server, coupled to communicate with the first and second computers via a computer network, and arranged to assess compatibility of the privacy preferences with the privacy policy, such that if the privacy preferences and the privacy policy are found to be incompatible, the server brokers a negotiation with at least one of the first and the second parties so as to bring the privacy preferences and the privacy policy into mutual compatibility, and further arranged to provide the information from the first party to the second party only when the privacy preferences and the privacy policy are found to be compatible.

41. A system for electronic commerce, comprising:
a buyer computer, operated by a buyer;
one or more seller computers, operated by respective sellers; and
an electronic commerce server coupled to communicate with the buyer and seller computers via a computer network, and arranged to establish a privacy policy restricting use of information to be revealed by the buyer computer to the server in connection with a transaction to be carried out by the buyer computer through the server and, subject to the privacy policy, to receive the information from the buyer computer, including a description of an item desired to be procured for the buyer, to identify one of the seller computers making an offer to supply the item, to receive from the seller computer an undertaking to restrict the use of the information in accordance with the privacy policy, and to provide the information to the seller computer, subject to the undertaking, responsive to which information the respective seller conveys the item to the buyer.

42. A computer software product for controlling an exchange of information between a first party and a second party, he product comprising a computer-readable medium in which program instructions are stored, which instructions, when read by a computer, cause the computer to receive from the first party a set of one or more privacy preferences, indicating restrictions to be placed on use of specified items of the information to be disclosed by the first party, and to receive from the second party a description of a privacy policy, indicating undertakings by the second party with regard to restricting the use of the specified items of the information, and to assess compatibility of the privacy preferences with the privacy policy, and if the privacy preferences and the privacy policy are found to be incompatible, to broker a negotiation with at least one of the first and the second parties so as to bring the privacy preferences and the privacy policy into mutual compatibility, and to provide the information from the first party to the second party only when the privacy preferences and the privacy policy are found to be compatible.

43. A computer software product for electronic commerce, the product comprising a computer-readable medium in which program instructions are stored, which instructions, when read by a computer, cause the computer to establish a privacy policy restricting use of information to be revealed by a buyer to an electronic marketplace in connection with a transaction to be carried out by the buyer through the marketplace, and subject to the privacy policy, to receive the information from the buyer, including a description of an item desired to be procured from the buyer, and to locate a seller in communication with the marketplace offering the item, and to receive from the seller an undertaking to restrict the use of the information in accordance with the privacy policy, and to provide the information to the seller, subject to the undertaking, responsive to which information the seller conveys the item to the buyer.
